(19) United States
(12) Patent Application Publication
(10) Pub. No.: US 2016/0227516 A1
(43) Pub. Date: Aug. 4, 2016

(54) SPARSITY AND CONTINUITY-BASED CHANNEL STITCHING TECHNIQUES FOR ADJACENT TRANSMISSIONS

(71) Applicant: QUALCOMM Incorporated, San Diego, CA (US)

(72) Inventors: Venkatesan NALLAMPATTI EKAMBARAM, Hillsboro, OR (US); Jubin JOSE, Belle Mead, NJ (US); Xinzhou WU, San Diego, CA (US); Thomas Joseph RICHARDSON, South Orange, NJ (US)

(21) Appl. No.: 15/012,731

(22) Filed: Feb. 1, 2016

Related U.S. Application Data
(60) Provisional application No. 62/111,643, filed on Feb. 3, 2015.

(51) Int. Cl. H04W 72/04

(52) U.S. Cl. CPC H04W 72/04

(57) ABSTRACT

A method, an apparatus, and a computer program product for wireless communication are provided. The device may receive a signal on each of N channels from another device. The N channels may include a first channel. The device may determine a frequency response of each of the N channels based on the received signals. The device may transform, from a frequency domain to a time domain, the N frequency responses in order to generate a transformed signal. The frequency response of an n^{th} channel of the N channels may be adjusted by a channel offset of the nth channel with respect to the first channel for n being each integer from 2 to N. The device may then estimate the channel offset for each of the N channels other than the first channel based on the transformed signal.

### CROSS-REFERENCE TO RELATED APPLICATION(S)

This application claims the benefit of U.S. Provisional Application Ser. No. 62/111,643, entitled “SPARSITY AND CONTINUITY-BASED CHANNEL STITCHING TECHNIQUES FOR ADJACENT TRANSMISSIONS” and filed on Feb. 3, 2015, which is assigned to the assignee hereof and expressly incorporated by reference herein in its entirety.

### BACKGROUND

1. Field

The present disclosure relates generally to communication systems, and more particularly, to sparsity and continuity-based channel stitching techniques for adjacent transmissions across multiple channels between wireless devices.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method and an apparatus are provided. The apparatus may be a first device. The first device receives a data signal on each of one or more channels including a first channel from a second device. The first device determines a frequency response for each of the one or more channels based on each received data signal. The first device transforms, from a frequency domain to a time domain, the determined frequency response for each of the one or more channels to generate a transformed signal. The first device determines a channel offset for each of the one or more channels other than the first channel based on each transformed signal. Further, the first device determines an aggregated channel offset based on the determined channel offset for each of the one or more channels.

Further, a present apparatus relates to wireless communication at a first device. The described aspects include means for receiving a data signal on each of one or more channels including a first channel from a second device. The described aspects further include means for determining a frequency response for each of the one or more channels based on each received data signal. The described aspects further include means for transforming, from a frequency domain to a time domain, the determined frequency response for each of the one or more channels to generate a corresponding transformed data signal. The described aspects further include means for determining a channel offset for each of the one or more channels other than the first channel based on each transformed data signal. The described aspects further include means for determining an aggregated channel offset based on the determined channel offset for each of the one or more channels.

In some aspects, a present computer-readable medium storing computer executable code relates to wireless communication at a first device. The described aspects include code for receiving a data signal on each of one or more channels including a first channel from a second device. The described aspects further include code for determining a frequency response for each of the one or more channels based on each received data signal. The described aspects further include code for transforming, from a frequency domain to a time domain, the determined frequency response for each of the one or more channels to generate a corresponding transformed data signal. The described aspects further include code for determining a channel offset for each of the one or more channels other than the first channel based on each transformed data signal. The described aspects further include code for determining an aggregated channel offset based on the determined channel offset for each of the one or more channels.

In another aspect of the disclosure, a method and an apparatus are provided. The apparatus may be a first device. The first device receives, from a second device, a data signal on each of a plurality of subcarriers of a first channel and a data signal on at least one subcarrier of a second channel. The first device determines a channel response for each of the plurality of subcarriers of the first channel. The first device estimates a second channel response for the at least one subcarrier of the second channel based on the determined channel responses of the plurality of subcarriers of the first channel. The first device determines a channel offset between the first channel and the second channel based on the determined channel response and the estimated channel response for the at least one subcarrier of the second channel.

Further, in some aspects, a present apparatus relates to wireless communication at a first device. The described aspects include means for receiving, from a second device, a data signal on each of a plurality of sub carriers of a first channel and a data signal on at least one subcarrier of a second channel. The described aspects further include means for determining a channel response for each of the plurality of subcarriers of the first channel. The described aspects further include means for estimating a second channel response for the at least one subcarrier of the second channel based on the determined channel responses of the plurality of subcarriers of the first channel. The described aspects further include means for determining a channel offset between the first channel and the second channel based on the determined channel response and the estimated second channel response for the at least one subcarrier of the second channel.

In some aspects, a present computer-readable medium storing computer executable code relates to wireless communication at a first device. The described aspects include code for receiving, from a second device, a data signal on each of a plurality of subcarriers of a first channel and a data signal on at least one subcarrier of a second channel. The described aspects further include code for determining a channel response for each of the plurality of subcarriers of the first channel. The described aspects further include code for estimating a second channel response for the at least one subcarrier of the second channel based on the determined channel responses of the plurality of subcarriers of the first channel. The described aspects further include code for determining a channel offset between the first channel and the second channel based on the determined channel response and the estimated second channel response for the at least one subcarrier of the second channel.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B (eNodeB) and a user equipment (UE) in an access network.

FIG. 7A is a diagram illustrating an example of continuous carrier aggregation.

FIG. 7B is a diagram illustrating an example of non-continuous carrier aggregation.

FIG. 8 is a diagram illustrating wireless communication between a UE and an eNodeB.

FIGS. 9A and 9B are a flow charts of a method of wireless communication between two devices.

FIGS. 10A-10C illustrate a flow chart of a method of wireless communication between two devices.

FIG. 11 is a conceptual data flow diagram illustrating the data flow between different modules/means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

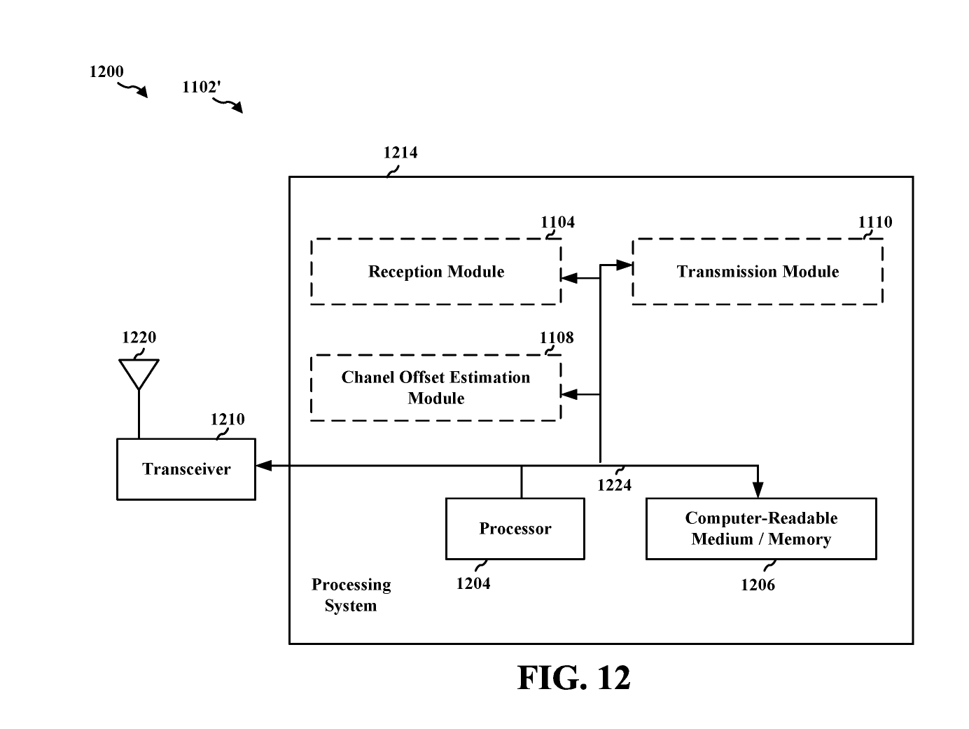

By way of example, an element or aspects, or any portion of an element or aspect, or any combination of elements or aspects may be implemented with a “processing system” that includes one or more processors (e.g., processing system 1214 including processor 1204, FIG. 12). Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary aspects, the functions and/or methods described may be implemented in hardware, software, or combinations thereof. If implemented in software, the functions and/or methods may be stored on or encoded as one or more instructions or code on a computer-readable medium. In some aspects, the computer-readable medium may be a non-transitory computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), phase change memory (PCM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

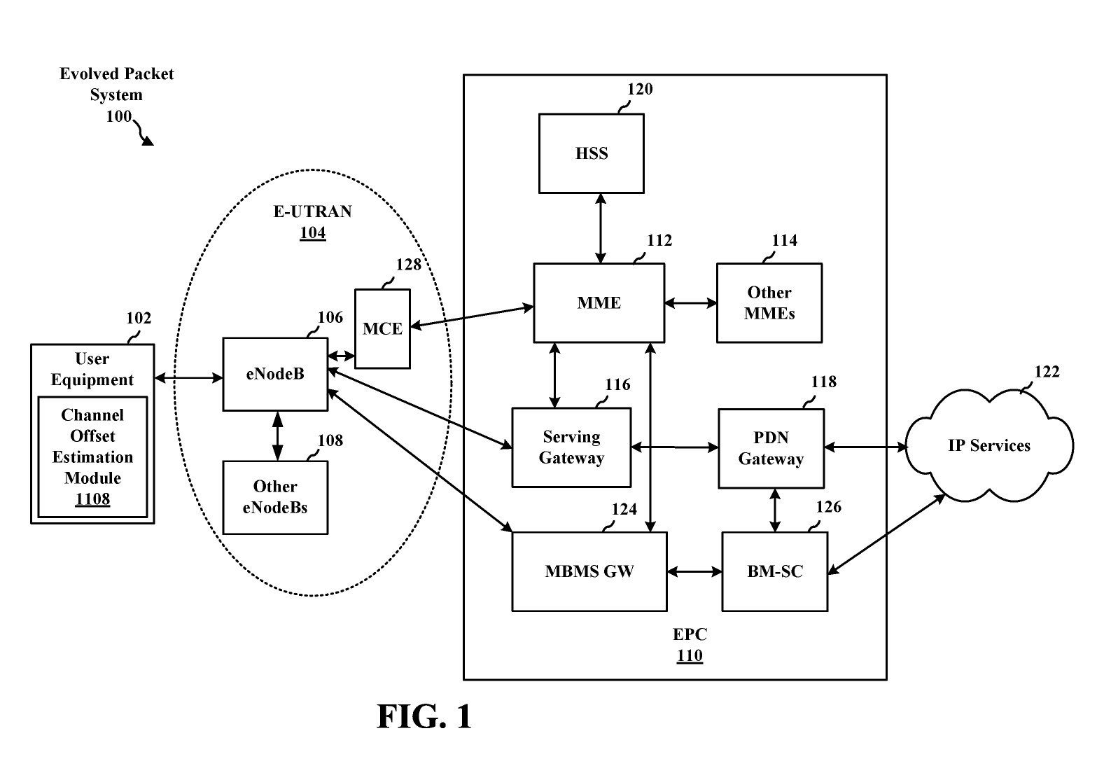

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. In some aspects, UE 102 may include channel offset estimation module 1108, which may be configured to determine a time-of-arrival (ToA) estimation (e.g., between the channel offset estimation module and another device (e.g., another UE)) based on, for example, a determined channel offset for each of one or more channels and obtaining an aggregated channel offset. The EPS can interconnect with other access networks, but for simplicity, those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108, and may include a Multicast Coordination Entity (MCE) 128. The eNodeB 106 provides user and control planes protocol terminations toward the UE 102. The eNodeB 106 may be connected or coupled to the other eNodeBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNodeB 106. The eNodeB 106 may also be referred to as a base station, a Node B, an access point, a base transceiver station, a radio base station, a radio transceiver, a transceiver function, a basic service set (BSS), an extended service set (ESS), or some other suitable terminology.

The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a navigation device (e.g., global positioning system), a multimedia device, a video device, a digital audio player (e.g., MP3 player), a camera, a game console, a tablet, a netbook, a smartbook, an ultrabook, a power meter, a security monitor, a smart light switch, a thermometer, a temperature control device, a healthcare/medical device, a wearable device (e.g., a smart watch, a smart wristband), a robot, a drone, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected or coupled to the EPC 110. The EPC 110 may include a Mobility Management Entity (MME) 112, a Home Subscriber Server (HSS) 120, other MMES 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which is connected or coupled to the PDN Gateway 118. The PDN Gateway 118 provides UE IP address allocation as well as other functions. The PDN Gateway 118 and the BM-SC 126 are connected or coupled to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNodeBs (e.g., 106, 108) belonging to a Multicast Broadcast Single Frequency Network (MBSFN) area broadcasting a particular service, and may be responsible for session management (start/stop) and for collecting eMBMS related charging information.

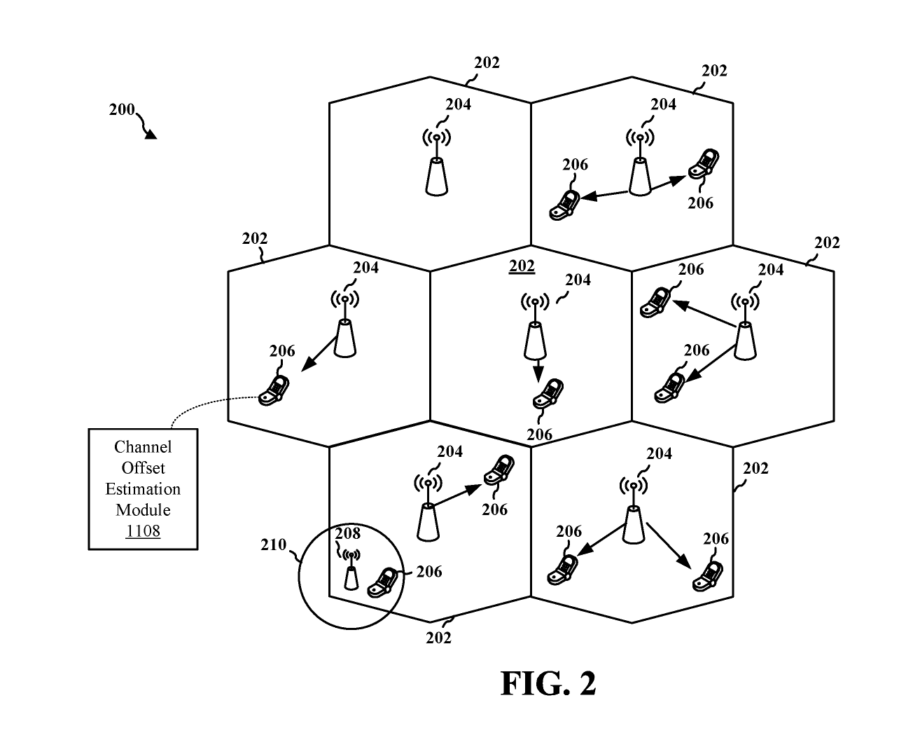

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. The lower power class eNodeB 208 may be a femto cell (e.g., home eNodeB (HeNodeB)), pico cell, micro cell, or remote radio head (RRH). The macro eNodeBs 204 are each assigned to a respective cell 202 and are configured to provide an access point to the EPC 110 for all the UEs 206 in the cells 202. In some aspects, each UE 206 may include channel offset estimation module 1108, which may be configured to determine a ToA estimation (e.g., between the channel offset estimation module and another device (e.g., another UE)) based on, for example, a determined channel offset for each of one or more channels and obtaining an aggregated channel offset.

There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116. An eNodeB may support one or multiple (e.g., three) cells (also referred to as a sectors). The term “cell” can refer to the smallest coverage area of an eNodeB and/or an eNodeB subsystem serving a particular coverage area. Further, the terms “eNodeB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

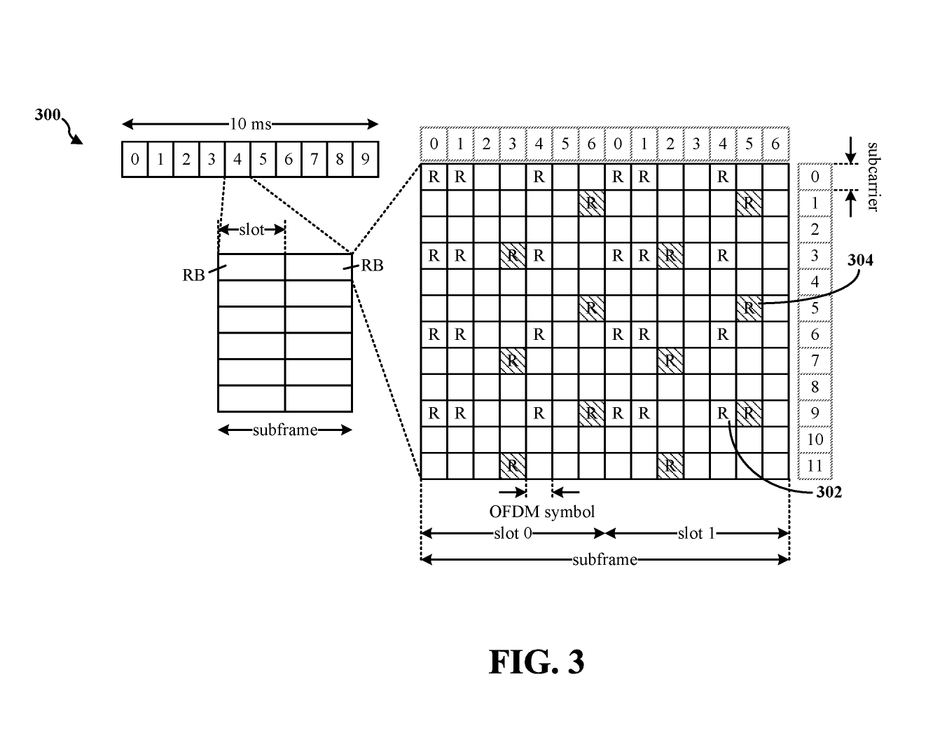

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

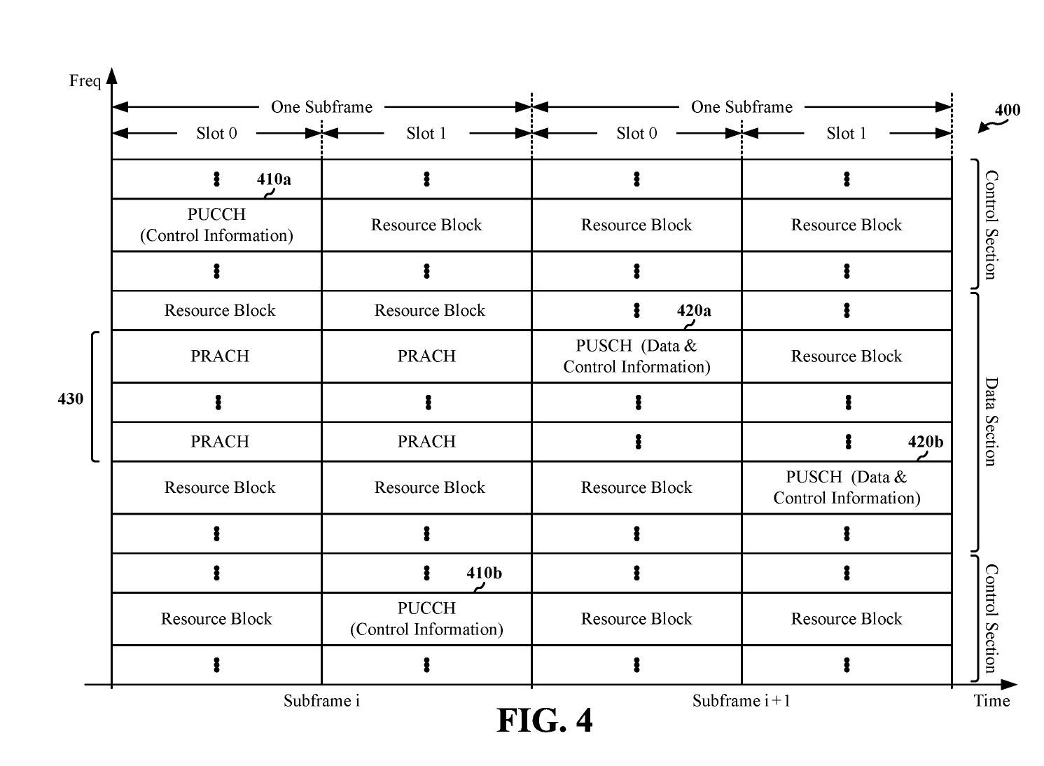

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section. A UE may be assigned resource blocks 410a, 410b in the control section to transmit control information to an eNodeB. The UE may also be assigned resource blocks 420a, 420b in the data section to transmit data to the eNodeB.

The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency. A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

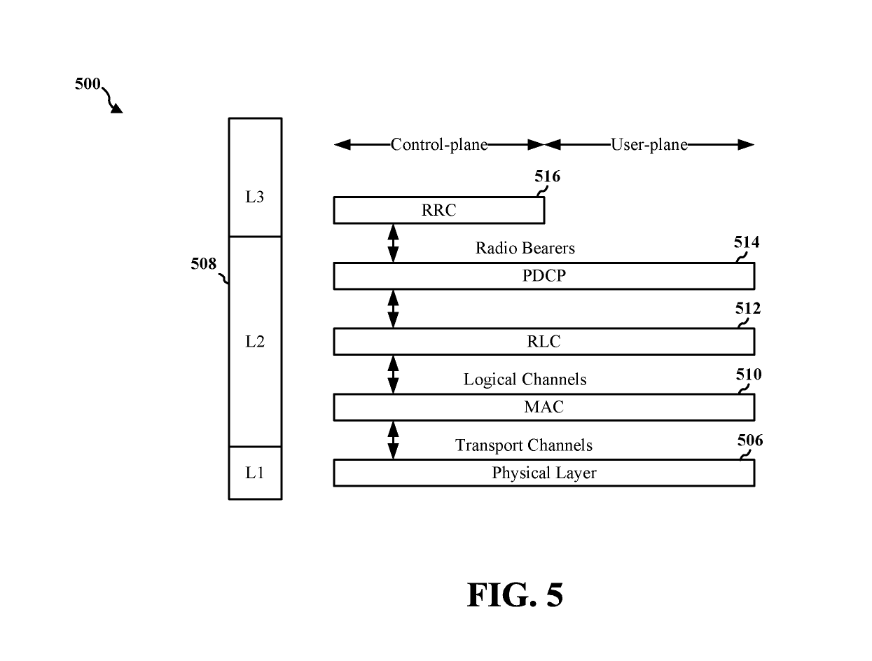

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARD). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNodeB and the UE.

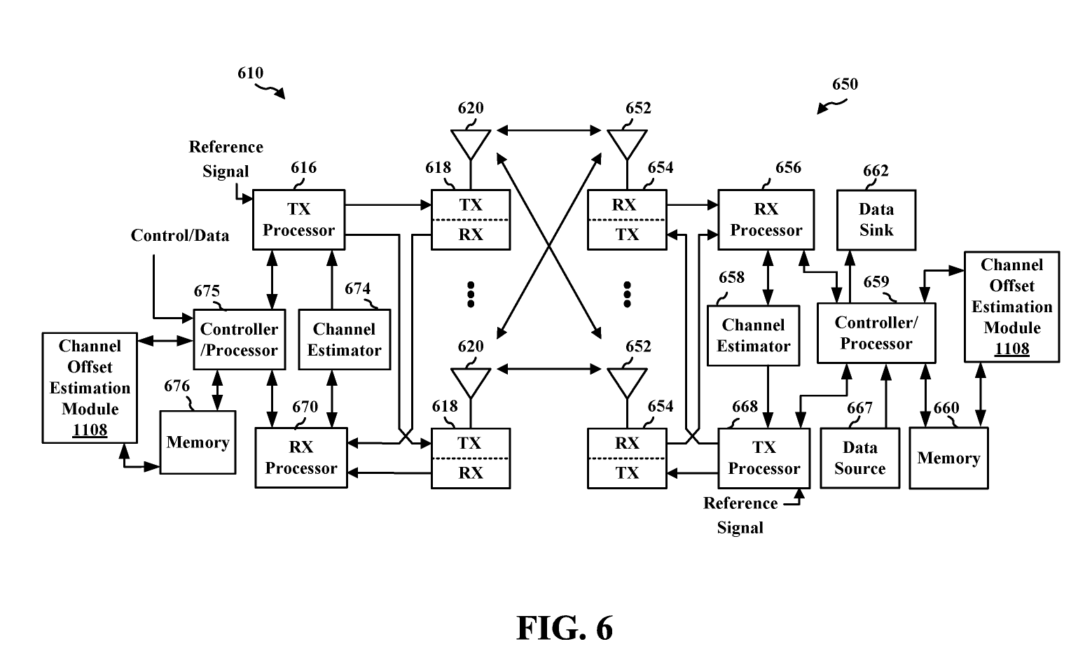

FIG. 6 is a block diagram of an eNodeB 610 in communication with a UE 650 in an access network. In the DL, upper layer packets from the core network are provided to a controller/processor 675. The controller/processor 675 implements the functionality of the L2 layer and/or L3 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (e.g., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 may implement the L2 layer and/or L3 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations. In some aspects, one or both of UE 650 and eNodeB 610 may include channel offset estimation module 1108, which may be configured to determine a ToA estimation (e.g., between the channel offset estimation module and another device (e.g., another UE)) based on, for example, a determined channel offset for each of one or more channels and obtaining an aggregated channel offset.

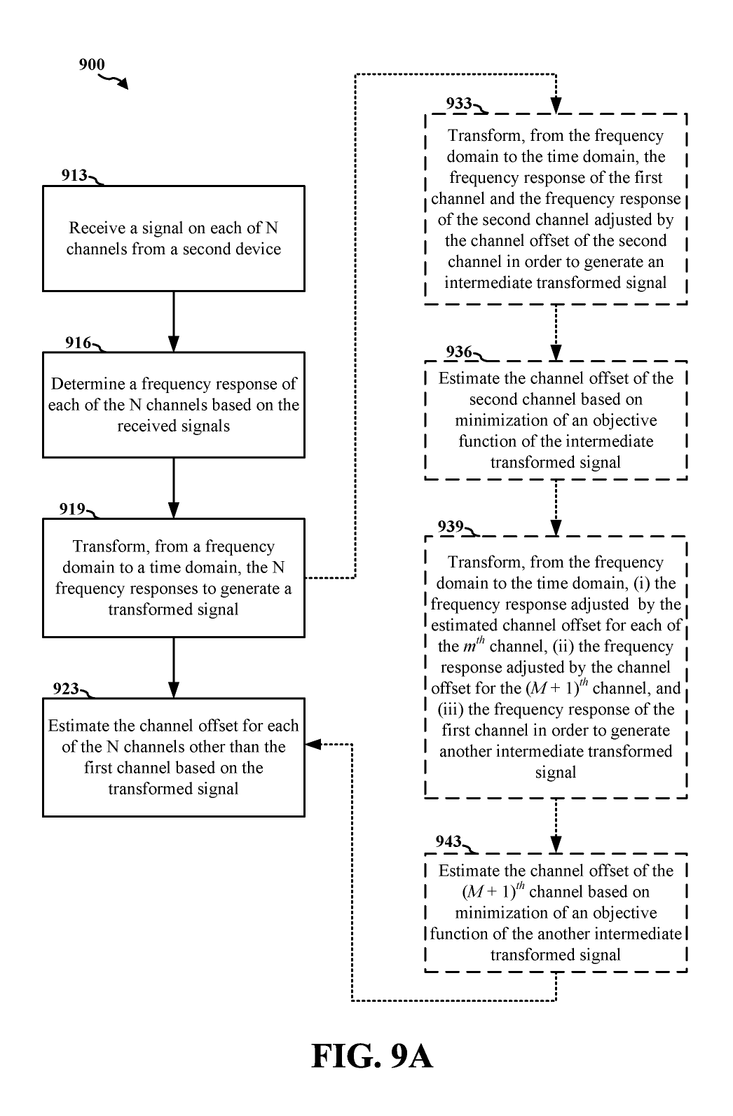

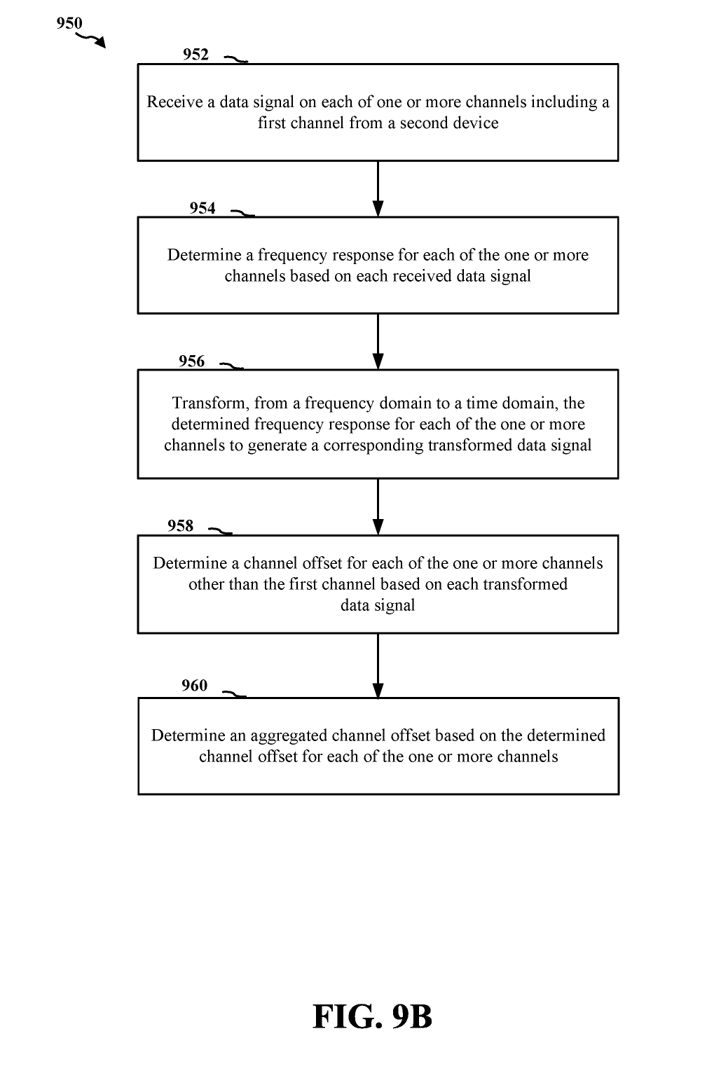

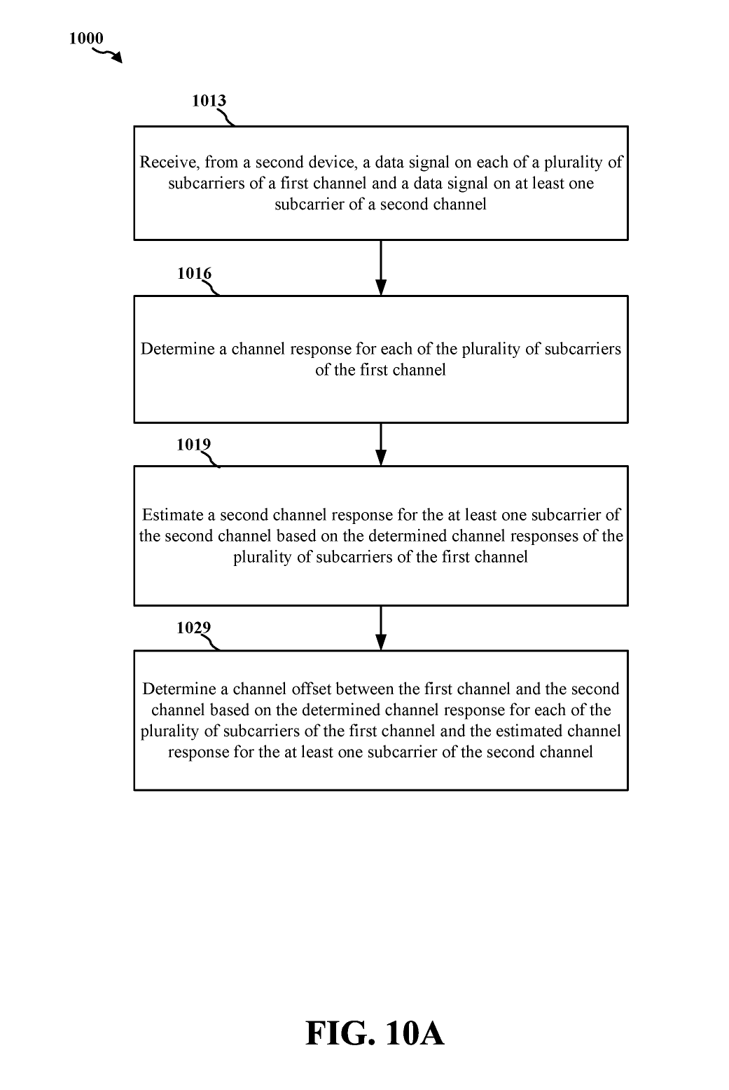

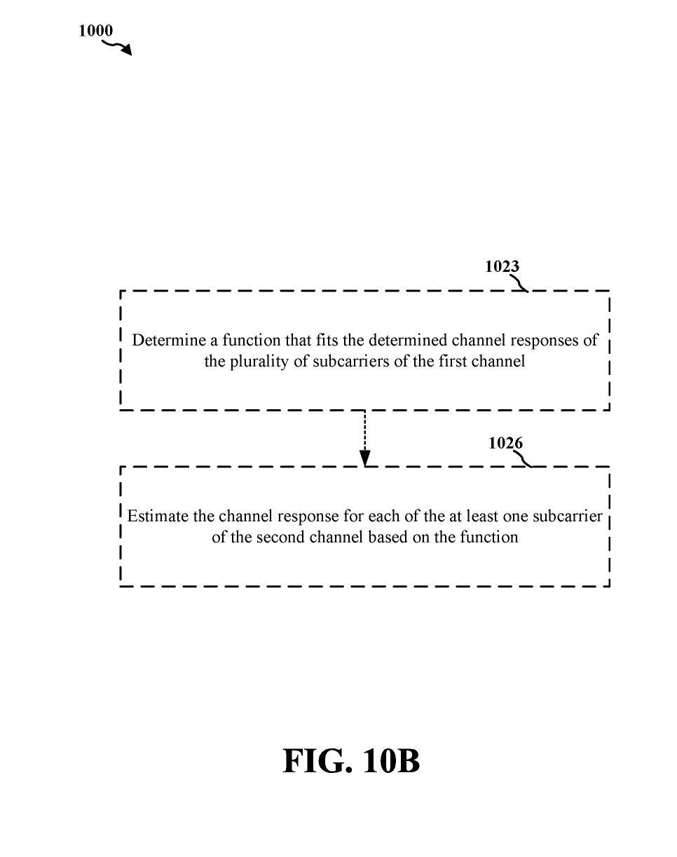

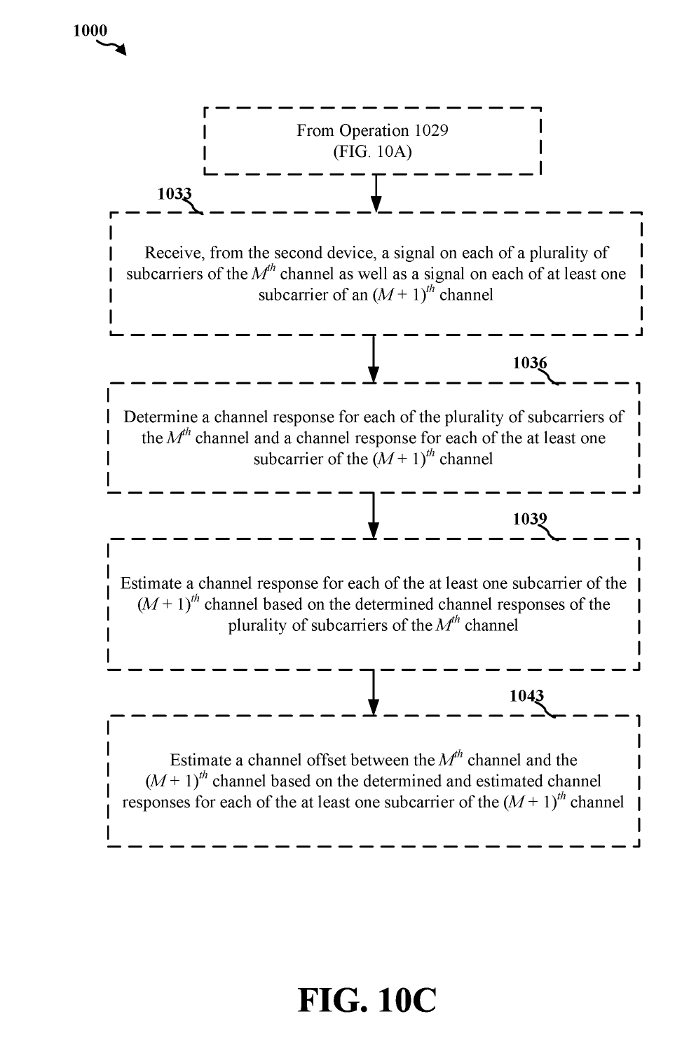

In the UL, a data source 667 is used to provide upper layer packets to the controller/processor 659. The data source 667 represents all protocol layers above the L2 layer. Similar to the functionality described in connection with the DL transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610. Controller/processor 659 may direct/perform operations of UE 650 (e.g., FIG. 9, FIG. 10).

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission. In some aspects, one or more modules and/or components of UE 650 may be modified and/or combined. For example, in some aspects, the controller/processor 659 may include or otherwise implement modules and/or components in one or more layers (e.g., L1, L2, and/or L3). In an example where the controller/processor 659 includes or otherwise implements the L1 and L2 layers the controller/processor 659 may include RX processor 656, TX processor 668, channel estimator 658, and/or channel offset estimation module 1108. Further, in some aspects where the controller/processor 659 includes or otherwise implements the L1, L2, and L3 layers, the controller/processor 659 may include RX processor 656, TX processor 668, channel estimator 658, channel offset estimation module 1108, data sink 662, and/or data source 667. One or more modules and/or components of eNodeB 610 may also be modified and/or combined as described above.

The UL transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer and/or L3 layer. Controller/processor 675 may direct/perform operations of eNodeB 610 and can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is responsible for error detection using an ACK and/or NACK protocol to support HARQ operations.

UEs may use spectrum up to 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 MHz. These asymmetric FDD assignments conserve spectrum and are a good fit for the typically asymmetric bandwidth utilization by broadband subscribers.

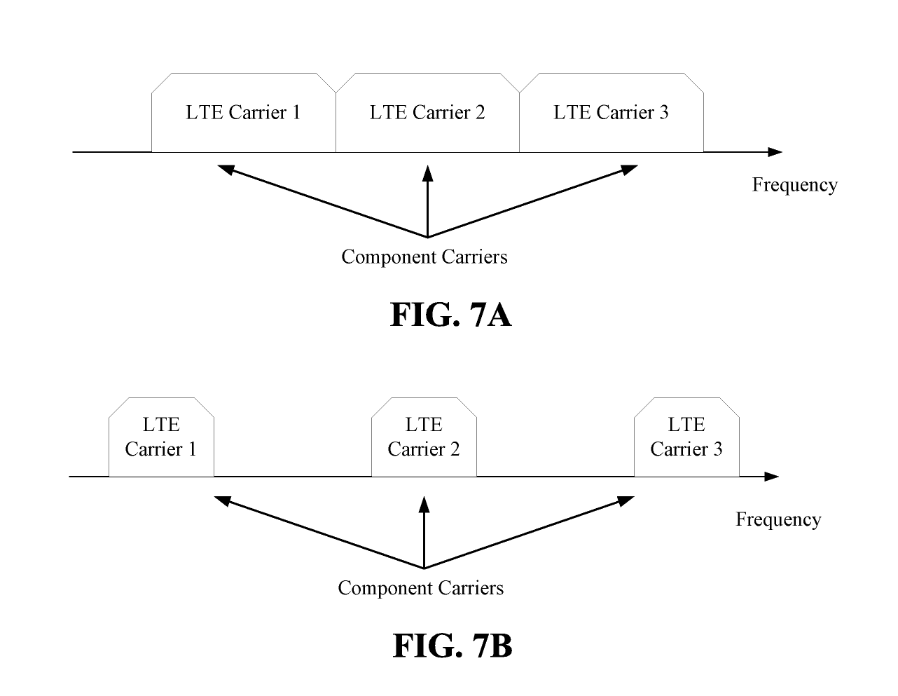

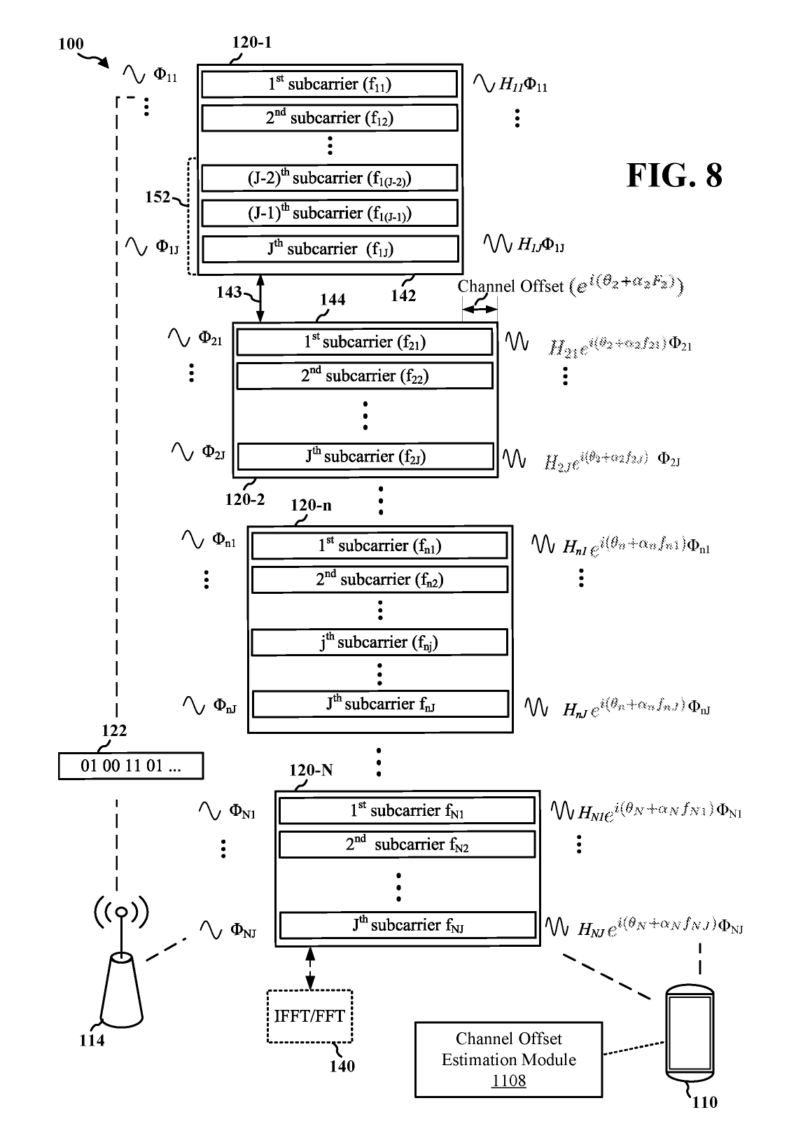

Two types of carrier aggregation (CA) methods have been proposed, continuous CA and non-continuous CA. The two types of CA methods are illustrated in FIGS. 7A and 7B. Non-continuous CA occurs when multiple available component carriers are separated along the frequency band (FIG. 7B). On the other hand, continuous CA occurs when multiple available component carriers are adjacent to each other (FIG. 7A). Both non-continuous and continuous CA aggregates multiple LTE/component carriers to serve a single UE.

ToA estimation is one of the physical-layer measurements used to obtain range/pseudo-range estimates between two or more wireless devices. Range/pseudo-range estimates may be used in indoor positioning and/or peer-to-peer (P2P) ranging. ToA estimation accuracy may be improved by using a higher bandwidth for transmission. The improved accuracy may result from the ability to better resolve close-by taps with a higher bandwidth. LTE allows for a band (e.g., carrier, channel) of, for example, 20 MHz bandwidth. Further, CA allows for higher transmission bandwidth of data by sending the data across multiple bands. As such, a larger bandwidth may improve ranging accuracy. Specifically, ToA message packet exchanges may be performed on different channels or frequencies. The channel frequency responses obtained from (some or all) these packets may be coherently stitched to obtain the channel frequency response for the entire bandwidth.

Wideband ranging techniques may improve non line-of-sight (NLOS) mitigation and time of flight accuracy. These techniques, however, may require that the phase of the received signals at different time instants be constant so that the packets can be stitched to obtain a larger bandwidth at a given time instant. Nonetheless, even with packets transmitted within coherence intervals, a channel offset, which includes a phase offset and a slope offset, may exist among the multiple channels partly due to different elements in the transmitter and/or receiver. Measurements show that phase offsets and slope offsets are relatively constant across a bandwidth of interest. Estimating or determining the phase offsets and the slope offsets amongst the adjacent bands in the received signals may improve ranging accuracy due to more accurate channel stitching.

In one aspect, the present disclosure is directed to techniques of estimating the channel offset introduced in the transmitter/receiver and to techniques of utilizing the channel offsets to coherently combine the values in the different bands to obtain a higher accuracy in channel stitching. Channel offsets may be introduced due to multiple reasons. One reason may be that the transmitter carrier phase is different for different packets at different time instants. Clock jitter and offsets introduced in the receiver chain may be other reasons.

In certain configurations, channel offsets are estimated based on the received frequency responses for multiple frequency channels. In certain configurations, the frequency bands are adjacent to each other.

In one technique, a channel impulse response is assumed to be reasonably sparse. That is, the number of taps of the channel impulse responses in the time domain is small (e.g., 1, 3, 5, or 7).

In one technique, continuity is assumed to exist at the boundaries of the different frequency channels. In other words, the frequency response at the boundary of one frequency channel to the boundary of the adjacent frequency channel may be continuous. That is, at the boundaries of the different frequency channels, a linear and/or polynomial relationship holds for the phase of the frequency response at least for a few frequencies (tones). In some aspects, the guard band spacing between the adjacent bands is relatively small. For example, in LTE CA, the guard band spacing is adjustable and may be a few hundred kHz apart. Using the continuity based techniques on multiple frequency channels may provide a performance equivalent to that of coherently transmitting over the entire bandwidth.

Further, these techniques will be further described infra using an eNodeB and a UE as an example. In some aspects, UE 810 may include or otherwise perform the techniques using or via channel offset estimation module 1108. Further, in some aspects, UE 810 may be the same as and/or include some or all of the features of UE 102 (FIG. 1), UE 206 (FIG. 2), and/or UE 650 (FIG. 6). These techniques, nonetheless, can be equally applied to two UEs, a station and an access point in a wireless local area network (WLAN), two stations in a WLAN, or two other wireless communication devices. The communication link between two wireless communication devices may be established in accordance with wireless wide area network (WWAN) standards (e.g., LTE), WLAN standards (e.g., IEEE 802.11), or any other suitable wireless communication protocols.

FIG. 8 is a diagram 800 illustrating wireless communication between a UE and an eNodeB. An eNodeB 814 may communicate with a UE 810 on N channels 820-1, 820-2, . . . 820-N. Each channel has J subcarriers. N is an integer greater than or equal to 2. J is an integer greater than or equal to 1. The j^{th} subcarrier of the n^{th} channel 820-n has a frequency of fₙⱼ; j=1, 2, . . . , J (e.g., j is each integer greater than or equal to 1 and less than or equal to J); n=1, 2, . . . , N (e.g., n is each integer greater than or equal to 1 and less than or equal to N).

The eNodeB 814 may transmit a ToA message 822 to the UE 810 on the N channels 820 through carrier aggregation. In one example, the ToA message 822 may be spread to or via the N channels 820 for transmission. In one technique, the ToA message 822 or a part of the ToA message 822 may be modulated into (N·J) symbols Φ₁₁, Φ₁₂, . . . , Φ_{1J}, . . . , Φ₂₁, Φ₂₂, . . . , Φ_{2J}, . . . , Φ_{N1}, Φ_{N2}, . . . , Φ_{NJ} The (N·J) symbols are transmitted on the (N·J) subcarriers of the N channels 820. Specifically, the eNodeB 814 may transmit Φₙⱼ to the UE 810 on the j^{th} subcarrier of the n^{th} channel 820-n. Accordingly, the UE 810 receives an output signal Hₙⱼ·Φₙⱼ on the j^{th} subcarrier of the n^{th} channel 820-n, where Hₙⱼ is the frequency response of the j^{th} subcarrier of the n^{th} channel 820-n.

In certain scenarios, the N channels 820 may not be aligned (e.g., along frequency and/or time domain), and there may be offsets among the N channels 820. For example, the n^{th} channel may have a phase offset e^{iθ}^{ₙ} and a slope offset e^{iα}^{ₙ}^{F}^{ₙ} with respect to a reference channel of the N channels 820, where Fₙ represents a vector of frequencies (e.g., fₙ₁, fₙ₂, f_{nJ}) of the J subcarriers of the nₜₕ channel 820-n. The phase offset and the slope offset may be mainly a function of the time offset between the packets, and a first order estimate can be obtained based on timestamps. Any channel of the N channels 820 may be selected as the reference channel. In this example, the first channel 820-1 is used as the reference channel. Accordingly, the output signal received at the j^{th} subcarrier of the n^{th} channel 820-n may be represented as Hₙⱼ·Φₙⱼ·e^{i(θ}^{ₙ}^{+α}^{ₙ}^{f}^{ₙⱼ}⁾, where Hₙⱼ is the frequency response and e^{i(θ}^{ₙ}^{+α}^{ₙ}^{f}^{ₙⱼ}⁾ is the channel offset with respect to the first channel 820-1.

In one technique, the eNodeB 814 and the UE 810 may use IFFT/FFT 840 for transmission of the symbols of the ToA message 822. The eNodeB 814 transforms the symbols from the frequency domain to the time domain through an IFFT in order to generate a time domain signal. Subsequently, the eNodeB 814 transmits the time domain signal to the UE 810 over the air. The UE 810 receives the time domain signal, and then transforms the time domain signal to the frequency domain through an FFT to generate an output signal for each subcarrier. As described supra, the output signal for the j^{th} subcarrier of the n^{th} channel 820-n is Hₙⱼ·Φₙⱼ·e^{i(θ}^{ₙ}^{+α}^{ₙ}^{f}^{ₙⱼ}⁾. The UE 810 may observe or measure the frequency response of the j^{th} subcarrier of the n^{th} channel 820-n.

Further, in one technique, the channel offset (e.g., e^{i(θ}^{ₙ}^{+α}^{ₙ}^{f}^{ₙⱼ}⁾) may be estimated based on the below equation:

$$min \vert \vert ifft ( [ {H}_{11} , {H}_{12} , … , {H}_{1 j} , {H}_{21} {e}^{i ( {0}_{2} + α 2 f 21 ) ,} {H}_{22} {e}^{i ( {0}_{2} + α 2 f 22 ) ,} , … , {H}_{2 j} {e}^{i ( {0}_{2} + α 2 f 2 j ) , ,} … , {H}_{N 1} {e}^{i ( {0}_{N} + α NfN 1 ) ,} {H}_{22} {e}^{i ( {0}_{2} + α 2 f 22 ) ,} , … , {H}_{Nj} {e}^{i ( {0}_{N} + α NfNj )} ] ) \vert \vert 1. \qquad ( 1 )$$

where ifft( ) represents an IFFT that transforms a vector of channel responses adjusted by the channel offsets of the subcarriers of the N channels. Particularly, the IFFT uses Hₙⱼ·e^{i(θ}^{ₙ}^{+α}^{ₙ}^{f}^{ₙⱼ}⁾ as the coefficient applied to fₙⱼ of the j^{th} subcarrier of the n^{th} channel 820-n. The results of the ifft( ), which is a transformed signal in the time domain, can be represented as follows:

$${h}_{k} = \frac{1}{N \cdot J} ( {H}_{11} {e}^{- if 11 k} + {H}_{12} e {-}^{if 12 k} + … + {H}_{1 j} e {-}^{if 1 jk} + … + {H}_{1 J} e {-}^{if 1 Jk} + {H}_{21} {e}^{- if 21 k} {e}^{i ( {θ}_{2} + α 2 f 21 )} + … + {H}_{22} {e}^{- if 22 k} {e}^{i ( {θ}_{2} + α 2 f 22 )} + … + {H}_{2 j} {e}^{- if2 jk} {e}^{i ( {θ}_{2} + α 2 f 2 j )} + … + {H}_{2 J} {e}^{- if 2 Jk} {e}^{i ( {θ}_{2} + α 2 f 2 J )} + \\ … \\ … \\ {H}_{n 1} {e}^{- ifn 1 k} {e}^{i ( {θ}_{n} + α nfn 1 )} + {H}_{n 2} {e}^{- ifn 2 k} {e}^{i ( {θ}_{n} + α nfn 2 )} + … + {H}_{nj} {e}^{- ifnjk} {e}^{i ( {θ}_{n} + α nfnj )} + … + {H}_{nJ} {e}^{- ifnJk} {e}^{i ( {θ}_{n} + α nfnJ )} … \\ … \\ {H}_{N 1} {e}^{- ifN 1 k} {e}^{i ( {θ}_{N} + α NfN 1 )} + {H}_{2 N} {e}^{- ifN 2 k} {e}^{i ( {θ}_{N} + α NfN 2 )} + {…H}_{Nj} {e}^{- ifNjk} {e}^{i ( {θ}_{N} + α NfNj )} + … + {H}_{NJ} {e}^{- ifNJk} {e}^{i ( {θ}_{N} + α NfNJ )} . \\ n = 1 , 2 , … , N . \\ j = 1 , 2 , … , N . \qquad ( 2 )$$

hₖ is the k^{th} sample value of K sample values of the transformed time domain signal. K is an integer greater than 0. k is greater than 0 and less than or equal to K. hₖ can also be represented by the compact form:

$${h}_{k} = {\sum }_{n = 1}^{N} {\sum }_{j = 1}^{J} {H}_{nj} {e}^{- {if}_{nj} k} {e}^{i ( {θ}_{n} + {α}_{n} {f}_{nj} )} \\ {θ}_{1} = 0 , {α}_{1} = 0 \qquad ( 3 )$$

∥h∥₁ is one-norm and defined as:

$$\vert \vert h {\vert \vert}_{1} \text{:=} {\sum }_{k = 1}^{K} \vert {h}_{k} \vert$$

In this technique, the values of the θₙ and the αₙ (n=2, 3, . . . , N) are selected such that ∥h∥₁ is minimized. As such, the phase offset (e.g., e^{iθ}^{ₙ}) and the slope offset (e.g., e^{iα}^{ₙ}^{f}^{ₙⱼ}) of the n^{th} channel 820-n can be estimated. Further, instead of one-norm, the UE 810 may estimate the phase offset and the slope offset of the n^{th} channel 820-n by minimizing other suitable objective functions of the transformed signal (e.g., results of the ifft( )).

Further, in one technique, in order to determine the phase offset and the slope offset for each channel, the phase offset and the slope offset of a first selected channel may be initially determined. For example, the estimated phase offset (e.g., [symbol] ) and the slope offset (e.g., [symbol] ) of the second channel 820-2 may be initially determined based on the below equation:

min∥ifft⁽²⁾([H₁₁,H₁₂, . . . ,H_{1J},H₂₁e^{i(θ}^{₂}^{+α2f21)},H₂₂e^{i(θ}^{₂}^{+α2f22)}, . . . ,H_{2J}e^{i(θ}^{₂}^{+α2f2J)}])∥1. (4)

Similarly as described supra, the results of the ifft( )⁽²⁾, which is an intermediate transformed signal, can be represented as follows:

$${h}_{k}^{( 2 )} = {\sum }_{n = 1}^{2} {\sum }_{j = 1}^{J} {H}_{nj} {e}^{- {if}_{nj} k} {e}^{i ( {θ}_{n} + {α}_{n} {f}_{nj} )} \\ {θ}_{1} = 0 , {α}_{1} = 0 \qquad ( 5 )$$

The values of the θ₂ and the α₂ are selected such that ∥h⁽²⁾∥₁ is minimized. As such, the values of the θ₂ and the α₂ can be estimated as [symbol] and [symbol] . The channel responses and the channel offsets, e.g., G₂(F₁,F₂), of the first channel 820-1 and the second channel 820-2 (e.g., coefficients to be used in ifft( ) with respect to the frequencies of the first channel 820-1 and the second channel 820-2) can be represented as follows:

G₂(F₁,F₂):=[H₁(F₁),H₂(F₂) [symbol] ] (6)

Hₙ(Fₙ) is the channel response of the n^{th} channel 820-n. Hₙ(Fₙ) [symbol] is the channel response adjusted by the channel offset of the n^{th} channel 820-n. More specifically, Hₙ(Fₙ) represents a vector of channel responses of the subcarriers of the n^{th} channel 820-n: [Hₙ₁, Hₙ₂, . . . , H_{nJ}]. Hₙ(Fₙ) [symbol] represents a vector of channel responses of the subcarriers of the nth channel 820-n adjusted by their respective channel offsets: [Hₙ₁ [symbol] , Hₙ₂ [symbol] , . . . , Hₙⱼ [symbol] ].

Subsequently, another channel may be selected for estimation of the phase offset and slope offset of that channel. In the example, the third channel is selected. Similarly as described supra, the estimated [symbol] and [symbol] can be obtained through the below equation:

$$min \vert \vert {ifft}^{3} ( [ \begin{matrix}{G}_{2} ( {F}_{1} , {F}_{2} ) , {H}_{1} ( {F}_{1} ) , {H}_{31} {e}^{i ( {θ}_{3} + {α}_{3} {f}_{31} )} , \\ {H}_{32} {e}^{i ( {θ}_{3} + {α}_{3} {f}_{32} )} , {H}_{3 J} {e}^{i ( {θ}_{3} + {α}_{3} {f}_{3 J} )}\end{matrix} ] \} \vert \vert 1. \qquad ( 7 )$$

The channel responses and the estimated channel offsets, e.g., G₃(F₁,F₂,F₃) of the first channel 820-1, the second channel 820-2, and the third channel (e.g., coefficients to be used in ifft( ) with respect to the frequencies of the first channel 820-1, the second channel 820-2, and the third channel) can be represented as follows:

G₃(F₁,F₂,F₃):=[G₂(F₁,F₂),H₃(F₃)e [symbol] ]. (8)

This procedure may be repeated to select and estimate the phase offset and slope offset of the next channel until the phase offset and slope offset of each of the N channels 820 have been estimated. For example, when the channel offsets of the first channel 820-1 to the Mₜₕ channel 820-M have been estimated, M being an integer greater than 2 and less than N, the channel responses and the estimated channel offsets, e.g., G_{M}(F₁, . . . , F_{M}), of the first channel 820-1 to the Mₜₕ channel 820-M (e.g., coefficients to be used in ifft( ) with respect to the frequencies from the first channel 820-1 to the Mₜₕ channel 820-M) can be represented as follows:

G_{M}(F₁, . . . ,F_{M}):=[G_{M-1}(F₁, . . . ,F_{M-1}),H_{M}(F_{M}) [symbol] ]. (9)

G₁(F₁):=H₁(F₁). (10)

Accordingly, the estimated phase offset (eⁱ [symbol] ) and slope offset (eⁱ [symbol] ^{F}^{_{M}}⁺¹) of the (M+1)ₜₕ channel can be obtained based on the below equation:

min∥ifft^{(M+1)}([G_{M}(F₁, . . . ,F_{M}),H_{(M+1)1}e^{i(θ}^{_{(M+1)}}^{+α}^{_{(M+1)}}^{f(M+1)1}),H_{(M+1)2}e^{i(θ}^{_{(M+1)}}^{+α}^{_{(M+1)}}^{f}^{_{(M+1)2}}⁾, . . . ,H_{(M+1)J}e^{i(θ}^{_{(M+1)}}+α_{(M+1)}f_{(M+1)J)}])∥1. (11)

G_{N}(F₁, . . . , F_{N}) may represent the overall frequency response obtained by combining the individual frequency responses from the first channel 820-1 to the Nₜₕ channel. The overall frequency response can then be used for example to estimate the ToA. The ToA estimate accuracy may correspond to or be proportional with the overall bandwidth obtained by combining all the frequency responses of the N channels 820 using the slope offset and phase offset estimates. As such, the ToA estimate accuracy may increase as the frequency responses for the N channels 820 forming the overall bandwidth are combined or aggregated.

In some aspects, two adjacent channels of the N channels 820 may be close to each other. In other words, the spacing between the adjacent edges of the two adjacent channels is relatively small. For example, the first channel 820-1 and the second channel 820-2 are adjacent. A spacing 843 between an edge 842 of the first channel 820-1 and an edge 844 of the second channel 820-2 may be less than 1 MHz (e.g., 150 KHz, 300 KHz, or 450 KHz.) The frequencies of the subcarriers from the first subcarrier of the first channel 820-1 to the j^{th} subcarrier of the first channel 820-1 and from the first subcarrier of the second channel 820-2 to the j^{th} subcarrier of the second channel 820-2 may be in an increasing order or in a decreasing order. Further, as described supra, the frequency response of the j^{th} subcarrier of the nₜₕ channel 820-n is Hₙⱼ. The phase of the frequency response Hₙⱼ, e.g., the phase response, is Ψₙⱼ.

In one technique, the UE 810 may measure the frequency responses of some or all of the subcarriers (e.g., two subcarriers, three subcarriers, or four subcarriers) within a selected frequency range 852 of the first channel 820-1 and near the edge 842. In this example, the UE 810 measures the frequency responses H₁₍ⱼ₋₂₎, H₁₍ⱼ₋₂₎, and H₁₍ⱼ₎ of the (j−2)^{th}, (j−1)^{th}, and j^{th} subcarriers of the first channel 820-1. Using the measured frequency responses (e.g., H₁₍ⱼ₋₂₎, H₁₍ⱼ₋₂₎, and H₁₍ⱼ₎) and the corresponding frequencies (e.g., f₁₍ⱼ₋₂₎, f₁₍ⱼ₋₁₎, and f₁ⱼ), the UE 810 may determine a polynomial or expression that defines the relationship between the frequencies and the frequency responses. For example, the UE 810 may fit a polynomial to the H₁₍ⱼ₋₂₎, H₁₍ⱼ₋₂₎, and H₁₍ⱼ₎ as well as the f₁₍ⱼ₋₂₎, f₁₍ⱼ₋₁₎, and f₁ⱼ. The polynomial may be represented as:

H^{(p)}(f)=αₗf^{l}+αₗ₋₁f^{l-1}+ . . . +α₂f²+α₁f+α₀. (12)

l is an integer greater than 1.

Further, using the determined polynomial, the UE 810 can obtain, through extrapolating, a frequency response at a selected frequency of the adjacent second channel. Thus, the UE 810 may determine the channel offset of the second channel with respect to the first channel by comparing the frequency response according to the polynomial with the actual measured frequency response at the selected frequency. For example, the UE 810 can obtain the values H^{(p)}(f₂₁) and H^{(p)}(f₂₂), which are the frequency responses at frequency f₂₁ and frequency f₂₂, respectively, according to the determined polynomial. Then, the UE 810 can compare H^{(p)}(f₂₁) and H^{(p)}(f₂₂) with the measured H₂₁ and H₂₂ to estimate the phase offset (e^{iθ}^{₂}) and the slope offset (e^{iα}^{₂}^{F}^{₂}) of the second channel 820-2. This technique may be applied to any two adjacent channels to determine the channel offset between the two channels.

Further, in another technique, instead of measuring the frequency responses, the UE 810 may measure phase responses and similarly determine a polynomial with respect to the phase response:

Ψ^{(p)}(f)=bₗf^{l}+bₗ₋₁f^{l-1}+ . . . +b₂f²+b₁f+b₀. (13)

Accordingly, using the phase response polynomial, the UE 810 can estimate phase offsets among or between two adjacent channels using the procedure described supra.

Subsequently, the UE 810 may select a third channel that is adjacent to the second channel 820-2 and similarly estimates a channel offset between the second channel 820-2 and the third channel. Because the channel offset between the first channel 820-1 and the second channel 820-2 has been estimated, the UE 810 may determine the estimated channel offset between the first channel 820-1 and the third channel. By using this technique repeatedly, the UE 810 may estimate a channel offset of each subsequent adjacent channel.

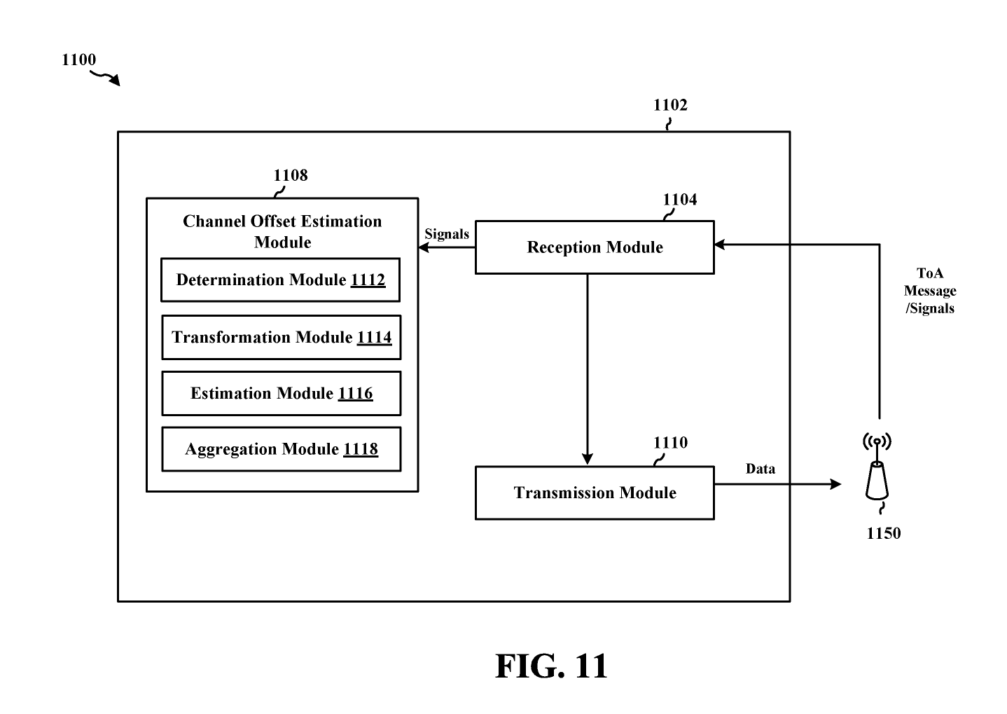

FIGS. 9A and 9B illustrate flow charts 900 and 950, respectively, of methods of wireless communication between two devices. The methods may be performed by a UE (e.g., the UE 810, the apparatus 1102/1102′) including channel offset estimation module 1108 (FIGS. 8 and 11). In some aspects, some of the operations or blocks depicted in flow charts 900 and 950 may be combined and/or omitted.

For example, referring to FIG. 9A, at operation 913, the UE may receive a signal on each of N channels from a second device. For instance, N is an integer greater than 1. In some aspects, the N channels include a first channel. For example, referring to FIG. 8, the UE 810 (e.g., via channel offset estimation module 1108 and/or reception module 1104, FIGS. 11 and 12) receives the ToA message 822 on the N channels 820 from the eNodeB 814. As such, in some aspects, the received signals may be ToA messages.

At operation 916, the UE may determine a frequency response of each of the N channels based on the received signals. For example, referring to FIG. 8, the UE 810 (e.g., via channel offset estimation module 1108 and/or determination module 1112, FIGS. 11 and 12) determines the channel response Hₙⱼ of the j^{th} subcarrier of the n^{th} channel 820-n.

At operation 919, the UE may transform, from a frequency domain to a time domain, the N frequency responses to generate a transformed signal. The frequency response of an n^{th} channel of the N channels may be adjusted by a respective channel offset of the n^{th} channel with respect to the first channel for n being each integer from 2 to N. For example, referring to FIG. 8, the UE 810 (e.g., via channel offset estimation module 1108 and/or transformation module 1114, FIGS. 11 and 12) may perform an IFFT that uses Hₙⱼ·e^{i(θ}^{ₙ}^{+α}^{ₙ}^{f}^{ₙⱼ}⁾ as the coefficient applied to fₙⱼ of the j^{th} subcarrier of the n^{th} channel 820-n.

At operation 923, the UE may estimate the channel offset for each of the N channels other than the first channel based on the transformed signal. For example, referring to FIG. 8, the UE 810 (e.g., via channel offset estimation module 1108, FIGS. 11 and 12) may select the values of the θₙ and the αₙ (n=2, 3, . . . , N) such that ∥h∥₁ is minimized. As such, the phase offset (e.g., e^{iθ}^{ₙ}) and the slope offset (e.g., e^{iα}^{ₙ}^{f}^{ₙⱼ}) of the n^{th} channel 820-n can be estimated.

In some aspects, the channel offset of each of the N channels other than the first channel is determined such that an objective function of the transformed signal is minimized. In some aspects, the objective function is one-norm. In some aspects, the channel offset includes at least one of a phase offset and a slope offset. In some aspects, transforming the N frequency responses is performed through an IFFT. The frequency response of the first channel is used as a coefficient of a frequency of the first channel during the IFFT. The frequency response of the n^{th} channel adjusted by the channel offset of the n^{th} channel is used as a coefficient of a respective frequency of the n^{th} channel during the IFFT (see, e.g., equation (2)).

For example, in some aspects, N is greater than 2. After or as part of operation 919, the UE, may at operation 933, optionally transform, from the frequency domain to the time domain, the frequency response of the first channel and the frequency response of the second channel adjusted by the channel offset of the second channel in order to generate an intermediate transformed signal (see, e.g., equation (4)). Further, at operation 936, the UE optionally estimates the channel offset of the second channel based on minimization of an objective function of the intermediate transformed signal (see, e.g., equation (5)).

In some aspects, an m^{th} channel of the N channels may have an estimated channel offset for m being each integer from 2 to M. M is an integer greater than 1 and less than N.

At operation 939, the UE may optionally transform, from the frequency domain to the time domain, (i) the frequency response adjusted by the estimated channel offset for each of the m^{th} channel, (ii) the frequency response adjusted by the channel offset for the (M+1)^{th} channel, and (iii) the frequency response of the first channel in order to generate another intermediate transformed signal (see, e.g., equations (9)-(10)). The channel offset of the (M+1)^{th} channel has not been estimated.

At operation 943, which may be performed as part or in lieu of operation 923, the UE may estimate the channel offset of the (M+1)^{th} channel based on minimization of an objective function of the another intermediate transformed signal (see, e.g., equation (11)).

Further, referring to FIG. 9B, at operation 952, a UE may receive a data signal on each of one or more channels including a first channel from a second device. For example, as described herein, UE 810 (FIG. 8) and/or apparatus 1102/1102′ (FIGS. 11 and 12) may be configured to execute reception module 1104 (FIGS. 11 and 12) to receive a data signal (e.g., data packets forming a ToA message) on each of one or more channels including a first channel from a second device (e.g., second UE). As a further example, referring to FIG. 8, the UE 810 (e.g., via channel offset estimation module 1108 and/or reception module 1104, FIGS. 11 and 12) may receive a data signal in the form of the ToA message 822 on the N channels 820 from the eNodeB 814.

At operation 954, the UE may determine a frequency response for each of the one or more channels based on each received data signal. For instance, as described herein, UE 810 (FIG. 8) may be configured to execute channel offset estimation module 1108 (FIGS. 8, 11, and 12) and/or one or more sub modules (e.g., determination module 1112, FIG. 11) to determine a frequency response (e.g., measure of magnitude and/or phase of the output as a function of frequency) for each of the one or more channels based on each received data signal. As an additional example, referring to FIG. 8, the UE 810 (e.g., via channel offset estimation module 1108 and/or determination module 1112, FIGS. 11 and 12) may determine a frequency response Hₙⱼ of the j^{th} subcarrier of the n^{th} channel 820-n. In some aspects, the frequency response may be determined for each subcarrier of each channel.

Further, at operation 956, the UE may transform, from a frequency domain to a time domain, the determined frequency response for each of the one or more channels to generate a corresponding transformed data signal. For example, as described herein, UE 810 (FIG. 8) may be configured to execute channel offset estimation module 1108 (FIGS. 8, 11, and 12) and/or one or more sub modules (e.g., transformation module 1114, FIG. 11) to transform (e.g., using an IIFT or FFT technique), from a frequency domain to a time domain, the determined frequency response for each of the one or more channels to generate a corresponding transformed data signal. As a further example, referring to FIG. 8, the UE 810 (e.g., via channel offset estimation module 1108 and/or transformation module 1114, FIGS. 11 and 12) may perform an IFFT that uses Hₙⱼ·e^{i(θ}^{ₙ}^{+α}^{ₙ}^{f}^{ₙⱼ}⁾ as the coefficient applied to fₙⱼ of the j^{th} subcarrier of the n^{th} channel 820-n to transform the determined frequency responses for each data signal. In some aspects, a data signal may be transformed for each subcarrier of each channel.

At operation 958, the UE may determine a channel offset for each of the one or more channels other than the first channel based on each transformed data signal. For instance, as described herein, UE 810 (FIG. 8) may be configured to execute channel offset estimation module 1108 (FIGS. 8, 11, and 12) and/or one or more sub modules (e.g., determination module 1112, FIG. 11) to determine a channel offset for each of the one or more channels other than the first channel based on each transformed data signal. As an additional example, referring to FIG. 8, the UE 810 (e.g., via channel offset estimation module 1108, FIGS. 11 and 12) may select the values of the θₙ and the αₙ (n=2, 3, . . . , N) such that νh∥₁ is minimized. As such, the phase offset (e.g., e^{iθ}^{ₙ}) and the slope offset (e.g., e^{iα}^{ₙ}^{f}^{ₙⱼ}) of the n^{th} channel 820-n can be estimated. In some aspects, the phase and slope offsets for each channel may be determined.

At operation 960, the UE may determine an aggregated channel offset based on the determined channel offset for each of the one or more channels. For instance, as described herein, UE 810 (FIG. 8) may be configured to execute channel offset estimation module 1108 (FIGS. 8, 11, and 12) and/or one or more sub modules (e.g., aggregation module 1118, FIG. 11) to determine or estimate an aggregated (e.g., coherently stitched) channel offset (e.g., for an entire bandwidth) based on the determined channel offset for each of the one or more channels (e.g., forming the entire bandwidth). In some aspects, an aggregated channel offset is the channel offset coherently formed across all of the one or more channels (e.g., for which a respective channel offset was determined). Additionally, in some aspects, the aggregated channel offset may be estimated or determined in the time domain and/or the frequency domain. As an example, referring to FIG. 8, the UE 810 (e.g., via channel offset estimation module 1108, FIGS. 11 and 12) may aggregate or coherently stitch each of the determined phase offsets (e.g., e^{iθ}^{ₙ}) and each of the determined slope offsets (e.g., e^{iα}^{ₙ}^{f}^{ₙⱼ}) of the n^{th} channel 820-n to obtain an aggregate channel offset.

Additionally, following operation 960, the UE may optionally perform ToA estimation based at least on the aggregated channel offset. For example, by performing ToA estimation, the UE may identify a range between the first device and the second device based on the aggregated channel offset. For example, as described herein, UE 810 (FIG. 8) may be configured to execute channel offset estimation module 1108 (FIG. 11) to identify or otherwise determine a range (or pseudo-range estimate) between the first device and the second device based on the aggregated channel offset.

FIGS. 10A-10C illustrate is a flow chart 1000 of a method of wireless communication between two devices. For example, the flow chart 1000 may enable a device such as a UE to determine a ToA estimation with respect to another device. The method may be performed by a UE (e.g., the UE 810, the apparatus 1102/1102′) including channel offset estimation module 1108 (FIGS. 8 and 11). In some aspects, some of the operations or blocks depicted in flow chart 1000 may be combined and/or omitted.

At operation 1013, the UE may receive, from a second device, a data signal on each of a plurality of subcarriers of a first channel and a data signal on at least one subcarrier of a second channel. In some aspects, the first channel and the second channel are adjacent channels selected from N channels. For example, N is an integer greater than 1. For example, referring to FIG. 8, the UE 810 (e.g., via channel offset estimation module 1108 and/or reception module 1104, FIGS. 11 and 12) receives the ToA message 822 on the N channels 820 from the eNodeB 814.

At operation 1016, the UE may determine a channel response for each of the plurality of subcarriers of the first channel. For example, referring to FIG. 8, the UE 810 (e.g., via channel offset estimation module 1108 and/or determination module 1112, FIGS. 11 and 12) measures the frequency responses H₁₍ⱼ₋₂₎, H₁₍ⱼ₋₂₎, and H₁₍ⱼ₎ of the (j−2)^{th}, the (j−1)^{th}, and the j^{th} subcarriers of the first channel 820-1.

At operation 1019, the UE may estimate a second channel response for the at least one subcarrier of the second channel based on the determined channel responses of the plurality of subcarriers of the first channel. For example, referring to FIG. 8, the UE 810 (e.g., via channel offset estimation module 1108 and/or estimation module 1116, FIGS. 11 and 12) can obtain the values H^{(p)}(f₂₁) and H^{(p)}(f₂₂), which are the frequency response at frequency f₂₁ and frequency f₂₂, respectively, according to the determined polynomial.

In some aspects, within or as part of operation 1019, the UE may optionally determine, at operation 1023, a function or expression that fits or satisfies the determined channel responses of the plurality of subcarriers of the first channel.

Further, at operation 1026, the UE may optionally estimate the channel response for the at least one subcarrier of the second channel based on the function (see, e.g., equation (13)).

At operation 1029, the UE may determine a channel offset between the first channel and the second channel based on the determined channel response and the estimated second channel response for the at least one subcarrier of the second channel. For example, referring to FIG. 8, the UE 810 (e.g., via channel offset estimation module 1108, FIGS. 11 and 12) can compare H^{(p)}(f₂₁) and H^{(p)}(f₂₁) with the measured H21 and H21 to determine the phase offset (e^{iθ}^{₂}) and the slope offset (e^{iα}^{₂}^{F}^{₂}) of the second channel 820-2.

In some aspects, the function defines a polynomial. In some aspects, the channel response includes a frequency response. In some aspects, the channel response is a phase of a frequency response. In some aspects, the channel offset includes at least one of a phase offset and a slope offset.

In some aspects, N is greater than 2. An m^{th} channel of the N channels has an estimated channel offset for m being each integer from 2 to M. M is an integer greater than 1 and less than N.

At operation 1033, the UE may optionally receive, from the second device, a signal on each of a plurality of subcarriers of the M^{th} channel and a signal on each of at least one subcarrier of an (M+1)^{th} channel. The M^{th} channel and the (M+1)^{th} channel are adjacent channels.

At operation 1036, the UE may optionally determine a channel response for each of the plurality of subcarriers of the M^{th} channel and a channel response for each of the at least one subcarrier of the (M+1)^{th} channel.

At operation 1039, the UE may optionally estimate a channel response for each of the at least one subcarrier of the (M+1)^{th} channel based on the determined channel responses of the plurality of subcarriers of the M^{th} channel.

At operation 1043, the UE may optionally estimate a channel offset between the M^{th} channel and the (M+1)^{th} channel based on the determined and estimated channel responses for each of the at least one subcarrier of the (M+1)^{th} channel. For example, referring to FIG. 8, the UE 810 may (e.g., via channel offset estimation module 1108, FIGS. 11 and 12) select a third channel that is adjacent to the second channel 820-2 and similarly estimates a channel offset between the second channel 820-2 and the third channel. Because the channel offset between the first channel 820-1 and the second channel 820-2 has been estimated, the UE 810 may determine the estimated channel offset between the first channel 820-1 and the third channel. By using this technique repeatedly, the UE 810 may estimate a channel offset of each subsequent adjacent channel.

FIG. 11 is a conceptual data flow diagram 1100 illustrating the data flow between different modules/means/components in an exemplary apparatus 1102. The apparatus may be a UE such as UE 810 (FIG. 8). The apparatus includes a reception module 1104, a transmission module 1110, and a channel offset estimation module 1108.

In one aspect, the reception module 1104 may be configured to receive a data signal on each of one or more (N) channels from a second device (e.g., an eNodeB 1150 or another UE). N is an integer greater than 1. The data signals may represent one or more ToA messages. The N channels include a first channel. The reception module 1104 sends the data signals to the channel offset estimation module 1108. The channel offset estimation module 1108 may include determination module 1112, which may be configured to determine a frequency response of each of the N channels based on the received data signals. The channel offset estimation module 1108 may include transformation module 1114, which may be configured to transform, from a frequency domain to a time domain, the N frequency responses to generate a transformed data signal. The frequency response of an n^{th} channel of the N channels is adjusted by a respective channel offset of the n^{th} channel with respect to the first channel for n being each integer from 2 to N. The channel offset estimation module 1108 may include estimation module 1116, which may be configured to estimate the channel offset for each of the N channels other than the first channel based on the transformed data signal. Further, channel offset estimation module 1108 may include aggregation module 1118, which may be configured to obtain an aggregated channel offset based on the respective channel offset for each of the one or more channels.

In some aspects, the channel offset of each of the N channels other than the first channel is determined such that an objective function of the transformed signal is minimized. In some aspects, the objective function is one-norm. In some aspects, the channel offset includes at least one of a phase offset and a slope offset. In some aspects, the transforming is performed through an IFFT. The frequency response of the first channel is used as a coefficient of a frequency of the first channel during the IFFT. The frequency response of the n^{th} channel adjusted by the channel offset of the n^{th} channel is used as a coefficient of a respective frequency of the n^{th} channel during the IFFT.

In some aspects, N is greater than 2. To transform the N frequency responses and the estimating the channel offset, the channel offset estimation module 1108 may be configured to transform, from the frequency domain to the time domain, the frequency response of the first channel and the frequency response of the second channel adjusted by the channel offset of the second channel in order to generate an intermediate transformed signal. The channel offset estimation module 1108 may be configured to estimate the channel offset of the second channel based on minimization of an objective function of the intermediate transformed signal.

In some aspects, an m^{th} channel of the N channels has an estimated channel offset for m being each integer from 2 to M. M is an integer greater than 1 and less than N. The channel offset estimation module 1108 may be configured to transform, from the frequency domain to the time domain, (i) the frequency response adjusted by the estimated channel offset for each of the m^{th} channel, (ii) the frequency response adjusted by the channel offset for the (M+1)^{th} channel, and (iii) the frequency response of the first channel in order to generate another intermediate transformed signal. The channel offset of the (M+1)^{th} channel has not been estimated. The channel offset estimation module 1108 may be configured to estimate the channel offset of the (M+1)^{th} channel based on minimization of an objective function of the another intermediate transformed signal.

In some aspects, the reception module 1104 may be configured to receive, from a second device (e.g., an eNodeB 1150), a signal on each of a plurality of subcarriers of a first channel and a signal on each of at least one subcarrier of a second channel. The signals may represent one or more ToA messages. The first channel and the second channel are adjacent channels selected from N channels. N is an integer greater than 1. The reception module 1104 sends the signals to the channel offset estimation module 1108. The channel offset estimation module 1108 may be configured to determine a channel response for each of the plurality of subcarriers of the first channel and a channel response for each of the at least one subcarrier of the second channel. The channel offset estimation module 1108 may be configured to estimate a channel response for each of the at least one subcarrier of the second channel based on the determined channel responses of the plurality of subcarriers of the first channel. The channel offset estimation module 1108 may be configured to estimate a channel offset between the first channel and the second channel based on the determined and estimated channel responses for each of the at least one subcarrier of the second channel.

In some aspects, to estimate the channel response for each of the at least one subcarrier of the second channel, the channel offset estimation module 1108 may be configured to determine a function that fits the determined channel responses of the plurality of subcarriers of the first channel. The channel offset estimation module 1108 may be configured to estimate the channel response for each of the at least one subcarrier of the second channel based on the function.

In some aspects, the function defines, operates according to, or otherwise is a polynomial. In some aspects, the channel response includes a frequency response. In some aspects, the channel response is a phase of a frequency response. In some aspects, the channel offset includes at least one of a phase offset and a slope offset.

In some aspects, N is greater than 2. An m^{th} channel of the N channels has an estimated channel offset for m being each integer from 2 to M. M is an integer greater than 1 and less than N. The reception module 1104 may be configured to receive, from the second device, a signal on each of a plurality of subcarriers of the M^{th} channel and a signal on each of at least one subcarrier of an (M+1)^{th} channel. The M^{th} channel and the (M+1)^{th} channel are adjacent channels. The channel offset estimation module 1108 may be configured to determine a channel response for each of the plurality of subcarriers of the M^{th} channel and a channel response for each of the at least one subcarrier of the (M+1)^{th} channel. The channel offset estimation module 1108 may be configured to estimate a channel response for each of the at least one subcarrier of the (M+1)^{th} channel based on the determined channel responses of the plurality of subcarriers of the M^{th} channel. The channel offset estimation module 1108 may be configured to estimate a channel offset between the M^{th} channel and the (M+1)^{th} channel based on the determined and estimated channel responses for each of the at least one subcarrier of the (M+1)^{th} channel.

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1108, 1110, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception module 1104. In addition, the transceiver 1210 receives information from the processing system 1214, specifically the transmission module 1110, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system further includes at least one of the modules 1104, 1108, and 1110. The modules may be software modules running in the processor 1204, resident/stored in the computer readable medium/memory 1206, one or more hardware modules coupled to the processor 1204, or some combination thereof. The processing system 1214 may be a component of the UE 650 and may include the memory 660 and/or at least one of the TX processor 668, the RX processor 656, and the controller/processor 659.

In some aspects, the apparatus 1102/1102′ may be a first device. The apparatus 1102/1102′ includes means for receiving a signal on each of N channels from a second device. N is an integer greater than 1. The N channels include a first channel. The apparatus 1102/1102′ includes means for determining a frequency response of each of the N channels based on the received signals. The apparatus 1102/1102′ includes means for transforming, from a frequency domain to a time domain, the N frequency responses in order to generate a transformed signal. The frequency response of an n^{th} channel of the N channels is adjusted by a respective channel offset of the n^{th} channel with respect to the first channel for n being each integer from 2 to N. The apparatus 1102/1102′ includes means for estimating the channel offset for each of the N channels other than the first channel based on the transformed signal.

The channel offset of each of the N channels other than the first channel may be determined such that an objective function of the transformed signal is minimized. The objective function may be one-norm. The channel offset may include at least one of a phase offset and a slope offset.

The transforming may be performed through an IFFT. The frequency response of the first channel may be used as a coefficient of a frequency of the first channel during the IFFT. The frequency response of the n^{th} channel adjusted by the channel offset of the n^{th} channel may be used as a coefficient of a respective frequency of the n^{th} channel during the IFFT.

N may be greater than 2. To transform the N frequency responses and to estimate the channel offset, the means for transforming may be configured to transform, from the frequency domain to the time domain, the frequency response of the first channel and the frequency response of the second channel adjusted by the channel offset of the second channel in order to generate an intermediate transformed signal, and the means for estimating may be configured to estimate the channel offset of the second channel based on minimization of an objective function of the intermediate transformed signal.

An m^{th} channel of the N channels may have an estimated channel offset for m being each integer from 2 to M. M is an integer greater than 1 and less than N. The apparatus 1102/1102′ may include means for transforming, from the frequency domain to the time domain, (i) the frequency response adjusted by the estimated channel offset for each of the m^{th} channel, (ii) the frequency response adjusted by the channel offset for the (M+1)^{th} channel, and (iii) the frequency response of the first channel in order to generate another intermediate transformed signal. The channel offset of the (M+1)^{th} channel has not been estimated. The apparatus 1102/1102′ may include means for estimating the channel offset of the (M+1)^{th} channel based on minimization of an objective function of the another intermediate transformed signal.

In another configuration, the apparatus 1102/1102′ may be a first device. The apparatus 1102/1102′ includes means for receiving, from a second device, a signal on each of a plurality of subcarriers of a first channel and a signal on each of at least one subcarrier of a second channel. The first channel and the second channel are adjacent channels selected from N channels. N is an integer greater than 1. The apparatus 1102/1102′ includes means for determining a channel response for each of the plurality of subcarriers of the first channel and a channel response for each of the at least one subcarrier of the second channel. The apparatus 1102/1102′ includes means for estimating a channel response for each of the at least one subcarrier of the second channel based on the determined channel responses of the plurality of subcarriers of the first channel. The apparatus 1102/1102′ includes means for estimating a channel offset between the first channel and the second channel based on the determined and estimated channel responses for each of the at least one subcarrier of the second channel.

To estimate the channel response for each of the at least one subcarrier of the second channel, the means for estimating the channel offset may be configured to determine a function that fits the determined channel responses of the plurality of subcarriers of the first channel. The means for estimating may be configured to estimate the channel response for each of the at least one subcarrier of the second channel based on the function.

The function may define a polynomial. The channel response may include a frequency response. The channel response may be a phase of a frequency response. The channel offset may include at least one of a phase offset and a slope offset. N is greater than 2. An m^{th} channel of the N channels has an estimated channel offset for m being each integer from 2 to M. M is an integer greater than 1 and less than N. The apparatus 1102/1102′ may include means for receiving, from the second device, a signal on each of a plurality of subcarriers of the M^{th} channel and a signal on each of at least one subcarrier of an (M+1)^{th} channel. The M^{th} channel and the (M+1)^{th} channel are adjacent channels. The apparatus 1102/1102′ may include means for determining a channel response for each of the plurality of subcarriers of the M^{th} channel and a channel response for each of the at least one subcarrier of the (M+1)^{th} channel. The apparatus 1102/1102′ may include means for estimating a channel response for each of the at least one subcarrier of the (M+1)^{th} channel based on the determined channel responses of the plurality of subcarriers of the M^{th} channel. The apparatus 1102/1102′ may include means for estimating a channel offset between the M^{th} channel and the (M+1)^{th} channel based on the determined and estimated channel responses for each of the at least one subcarrier of the (M+1)^{th} channel.

The aforementioned means may be one or more of the aforementioned modules of the apparatus 1102 and/or the processing system 1214 of the apparatus 1102′ configured to perform the functions recited by the aforementioned means. As described supra, the processing system 1214 may include the TX Processor 668, the RX Processor 656, and the controller/processor 659. As such, in some aspects, the aforementioned means may be the TX Processor 668, the RX Processor 656, and the controller/processor 659 configured to perform the functions recited by the aforementioned means.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication at a first device, comprising:
receiving a data signal on each of one or more channels including a first channel from a second device;
determining a frequency response for each of the one or more channels based on each received data signal;
transforming, from a frequency domain to a time domain, the determined frequency response for each of the one or more channels to generate a corresponding transformed data signal;
determining a channel offset for each of the one or more channels other than the first channel based on each transformed data signal; and
determining an aggregated channel offset based on the determined channel offset for each of the one or more channels.

2. The method of claim 1, further comprising performing time-of-arrival estimation based at least on the aggregated channel offset.

3. The method of claim 1, wherein receiving on each the one or more channels includes receiving the data signal on each of N channels, N being an integer greater than 1, and wherein determining the channel offset for each of the one or more channels other than the first channel comprises determining the channel offset for each of the N channels other than the first channel.

4. The method of claim 3, wherein the channel offset of each of the N channels other than the first channel is determined such that an objective function of the transformed data signal is minimized, and wherein the objective function is one-norm.

5. The method of claim 3, wherein the frequency response of an n^{th} channel of the N channels is adjusted by a channel offset of the n^{th} channel with respect to the first channel for n being each integer from 2 to N.

6. The method of claim 3, wherein the channel offset for each of the N channels includes at least one of a phase offset or a slope offset.

7. The method of claim 6, wherein the transforming is performed through an inverse fast Fourier transform (IFFT), wherein the frequency response of the first channel is used as a coefficient of a frequency of the first channel during the IFFT; and
wherein the frequency response of the n^{th} channel adjusted by the channel offset of the n^{th} channel is used as a coefficient of a frequency of the n^{th} channel during the IFFT.

8. The method of claim 6, wherein N is greater than 2, wherein transforming the N frequency responses and determining the channel offset include:
transforming, from the frequency domain to the time domain, the frequency response of the first channel and a frequency response of a second channel adjusted by the channel offset of the second channel in order to generate an intermediate transformed signal; and
estimating the channel offset of the second channel based on minimization of an objective function of the intermediate transformed signal.

9. The method of claim 8, wherein an m^{th} channel of the N channels has an estimated channel offset for m being each integer from 2 to M, M being an integer greater than 1 and less than N, the method further comprising:
transforming, from the frequency domain to the time domain, (i) the frequency response adjusted by the estimated channel offset for each of the m^{th} channel, (ii) the frequency response adjusted by the channel offset for the (M+1)^{th} channel, and (iii) the frequency response of the first channel in order to generate another intermediate transformed signal; and
estimating the channel offset of the (M+1)^{th} channel based on minimization of an objective function of the another intermediate transformed signal.

10. A method of wireless communication at a first device, comprising:
receiving, from a second device, a data signal on each of a plurality of subcarriers of a first channel and a data signal on at least one subcarrier of a second channel;
determining a channel response for each of the plurality of subcarriers of the first channel;
estimating a second channel response for the at least one subcarrier of the second channel based on the determined channel responses of the plurality of subcarriers of the first channel; and
determining a channel offset between the first channel and the second channel based on the determined channel response for each of the plurality of subcarriers of the first channel and the estimated second channel response for the at least one subcarrier of the second channel.

11. The method of claim 10, wherein estimating the second channel response for the at least one subcarrier of the second channel includes:
determining an expression that satisfies the determined channel responses of the plurality of subcarriers of the first channel; and
estimating the channel response for the at least one subcarrier of the second channel based on the expression.

12. The method of claim 10, wherein the second channel response includes one or both of a frequency response or a phase of the frequency response.

13. The method of claim 10, wherein the estimated channel offset between the first channel and the second channel includes at least one of a phase offset or a slope offset.

14. The method of claim 10, wherein the first channel and the second channel are adjacent channels selected from N channels, N being an integer greater than 1.

15. The method of claim 14, wherein N is greater than 2, wherein an m^{th} channel of the N channels has an estimated channel offset for m being each integer from 2 to M, M being an integer greater than 1 and less than N, the method further comprising:
receiving, from the second device, a signal on each of a plurality of subcarriers of the M^{th} channel and a signal on each of at least one subcarrier of an (M+1)^{th} channel, wherein the M^{th} channel and the (M+1)^{th} channel are adjacent channels;
determining a channel response for each of the plurality of subcarriers of the M^{th} channel and a channel response for each of the at least one subcarrier of the (M+1)^{th} channel;
estimating a channel response for each of the at least one subcarrier of the (M+1)^{th} channel based on the determined channel responses of the plurality of subcarriers of the M^{th} channel; and
estimating a channel offset between the M^{th} channel and the (M+1)^{th} channel based on the determined and estimated channel responses for each of the at least one subcarrier of the (M+1)^{th} channel.

16. An apparatus for wireless communication, the apparatus being a first device, comprising:
a memory;
a transceiver configured to transmit and receive one or more data signals; and
at least one processor coupled to the memory and the transceiver, wherein the at least one processor is configured to:
receive a data signal on each of one or more channels including a first channel from a second device;
determine a frequency response for each of the one or more channels based on each received data signal;
transform, from a frequency domain to a time domain, the determined frequency response for each of the one or more channels to generate a corresponding transformed data signal;
determine a channel offset for each of the one or more channels other than the first channel based on each transformed data signal; and
determine an aggregated channel offset based on the determined channel offset for each of the one or more channels.

17. The apparatus of claim 16, wherein the processor is further configured to perform time-of-arrival estimation based at least on the aggregated channel offset.

18. The apparatus of claim 16, wherein to receive on each the one or more channels, the at least one processor is further configured to receive the data signal on each of N channels, N being an integer greater than 1, and wherein to determine the channel offset for each of the one or more channels other than the first channel, the at least one processor is further configured to determine the channel offset for each of the N channels other than the first channel.

19. The apparatus of claim 18, wherein the channel offset of each of the N channels other than the first channel is determined such that an objective function of the transformed data signal is minimized, and wherein the objective function is one-norm.

20. The apparatus of claim 18, wherein the frequency response of an n^{th} channel of the N channels is adjusted by a channel offset of the n^{th} channel with respect to the first channel for n being each integer from 2 to N.

21. The apparatus of claim 18, wherein the channel offset for each of the N channels includes at least one of a phase offset or a slope offset.

22. The apparatus of claim 21, wherein to transform the determined frequency response for each of the one or more channels, the at least one processor is further configured to transform based on an inverse fast Fourier transform (IFFT), and wherein the frequency response of the first channel is used as a coefficient of a frequency of the first channel during the IFFT; and
wherein the frequency response of the n^{th} channel adjusted by the channel offset of the n^{th} channel is used as a coefficient of a frequency of the n^{th} channel during the IFFT.

23. The apparatus of claim 21, wherein N is greater than 2, wherein to transform the N frequency responses and to estimate the channel offset, the at least one processor is further configured to:
transform, from the frequency domain to the time domain, the frequency response of the first channel and a frequency response of a second channel adjusted by the channel offset of the second channel in order to generate an intermediate transformed signal; and
estimate the channel offset of the second channel based on minimization of an objective function of the intermediate transformed signal.

24. The apparatus of claim 23, wherein an m^{th} channel of the N channels has an estimated channel offset for m being each integer from 2 to M, M being an integer greater than 1 and less than N, the at least one processor is further configured to:
transform, from the frequency domain to the time domain, (i) the frequency response adjusted by the estimated channel offset for each of the m^{th} channel, (ii) the frequency response adjusted by the channel offset for the (M+1)^{th} channel, and (iii) the frequency response of the first channel in order to generate another intermediate transformed signal, wherein the channel offset of the (M+1)^{th} channel has not been estimated; and
estimate the channel offset of the (M+1)^{th} channel based on minimization of an objective function of the another intermediate transformed signal.

25. An apparatus for wireless communication, the apparatus being a first device, comprising:
a memory;
a transceiver configured to transmit and receive one or more data signals; and
at least one processor coupled to the memory and the transceiver, wherein the at least one processor is configured to:
receive, from a second device, a data signal on each of a plurality of subcarriers of a first channel and a data signal on at least one subcarrier of a second channel;
determine a channel response for each of the plurality of subcarriers of the first channel;
estimate a second channel response for the at least one subcarrier of the second channel based on the determined channel responses of the plurality of subcarriers of the first channel; and
determine a channel offset between the first channel and the second channel based on the determined channel response for each of the plurality of subcarriers of the first channel and the estimated channel response for the at least one subcarrier of the second channel.

26. The apparatus of claim 25, wherein to estimate the second channel response for each of the at least one subcarrier of the second channel, the at least one processor is further configured to:
determine an expression that satisfies the determined channel responses of the plurality of subcarriers of the first channel; and
estimate the channel response for the at least one subcarrier of the second channel based on the expression.

27. The apparatus of claim 25, wherein the second channel response includes one or both of a frequency response or a phase of the frequency response.

28. The apparatus of claim 25, wherein the estimated channel offset between the first channel and the second channel includes at least one of a phase offset or a slope offset.

29. The apparatus of claim 25, wherein the first channel and the second channel are adjacent channels selected from N channels, N being an integer greater than 1.

30. The apparatus of claim 29, wherein N is greater than 2, wherein an m^{th} channel of the N channels has an estimated channel offset for m being each integer from 2 to M, M being an integer greater than 1 and less than N, the at least one processor is further configured to:
receive, from the second device, a signal on each of a plurality of subcarriers of the M^{th} channel and a signal on each of at least one subcarrier of an (M+1)^{th} channel, wherein the M^{th} channel and the (M+1)^{th} channel are adjacent channels;
determine a channel response for each of the plurality of subcarriers of the M^{th} channel and a channel response for each of the at least one subcarrier of the (M+1)^{th} channel;
estimate a channel response for each of the at least one subcarrier of the (M+1)^{th} channel based on the determined channel responses of the plurality of subcarriers of the M^{th} channel; and
estimate a channel offset between the M^{th} channel and the (M+1)^{th} channel based on the determined and estimated channel responses for each of the at least one subcarrier of the (M+1)^{th} channel.
